(19) United States
(12) Patent Application Publication
(10) Pub. No.: US 2025/0322301 A1
(43) Pub. Date: Oct. 16, 2025

(54) OPTIMIZING DATASET SPLITS FOR ARTIFICIAL INTELLIGENCE (AI) MODEL TRAINING PIPELINE

(71) Applicant: NVIDIA Corporation, Santa Clara, CA (US)

(72) Inventors: Lukas HUBER, Zurich (CH); Christoph ANGERER, Munich (DE); Elmar HAUSSMANN, Esslingen (DE); Eugen SAWIN, Schutterwald (DE); Michele FENZI, Firenze (IT); Muhammed ERDEM, München (DE); Michele FERRETTI, Munich (DE)

(21) Appl. No.: 18/782,003

(22) Filed: Jul. 23, 2024

(30) Foreign Application Priority Data
Apr. 10, 2024 (IT) 10202400000804

(51) Int. Cl. G06N 20/00

(52) U.S. Cl. CPC G06N 20/00

(57) ABSTRACT

The present disclosure relates reducing overlaps between different data subsets used in the training pipeline of AI models. A geographical region may be divided into a set of cells. A subset of cells of the set of cells that corresponds to an operating route may be grouped into an island of cells. Operating data from an operating session of a machine, in which the operating session corresponds to at least one cell of the subset of cells included in the island, may be assigned to the island. The island of cells may be assigned to a particular data subset category of data subset categories corresponding to artificial intelligence (AI) model training pipeline. The AI model training pipeline may be executed using the plurality of data subset categories.

### BACKGROUND

Machines that perform autonomous and/or semi-autonomous navigation operations, which may be referred to herein as “ego-machines”, may use frameworks built on extensive hours of operating data. Such frameworks may be built using artificial intelligence (AI) models (e.g., machine learning models, neural networks, etc.). For example, the AI models may be trained using the operating data. The operating data may be obtained using different machines traveling along various routes. Such operating data may provide the AI models with different operational scenarios that the ego-machines may face in operation.

Some approaches of training and testing the AI models may include dividing the operating data into a first subset and a second subset. The first subset may be used as training data that trains the AI models in learning the patterns and relationships between inputs and outputs. The second subset may be used as validation data. The validation data may be used to assess performance of the AI models during training. For example, as the AI models are trained, the validation data may be used to assess current performance of the AI models. Additionally or alternatively, the operating data may be divided into a third subset of data. The third subset may be used as the testing data for the AI models. For example, the testing data may be used to test the AI models after the AI models have been trained using the first subset and/or the second subset.

Such traditional approaches may present data leakage issues. For example, in dividing the operating data into different subsets of data, the subsets used for training, validation, and/or testing may have overlapping data. The data leakage may cause the AI models to appear as performing better than actual performance. For example, in instances in which an overlap exists between the training subset and the testing subset, the testing results may reflect incorrectly good performance due to the use of the same data in testing as that used in training. Such overlap may lead to an improper and/or inaccurate perspective of the effectiveness of the AI models.

### SUMMARY

According to one or more embodiments of the present disclosure, systems and methods may be configured to help reduce overlaps between training data, validation data, and/or testing data used in the training of AI models. In particular, in some embodiments, a geographical region may be divided into a set of cells. A subset of cells of the set of cells that corresponds to an operating route may be grouped into an island of cells. The operating route may correspond to adjacent regions traveled by a machine during a particular operating session. Operating data from an operating session of a machine, in which the operating session corresponds to at least one cell of the subset of cells included in the island, may be assigned to the island. The island may be assigned to a particular data subset category of data subset categories corresponding to artificial intelligence (AI) model training pipeline. An AI model training pipeline may be executed using the plurality of data subset categories.

The embodiments of the present disclosure may help overcome some deficiencies of training models for navigational operations. The embodiments of the present disclosure may include a method of assigning data to specific subsets of data to be used for one or more models. Data may be divided between data subsets such that data corresponding to a particular geographical region is only assigned to one data subset. The particular geographical region may correspond to a particular driving session. For example, a data-gathering machine may operate from a first point to a second point, in which the particular geographical region may encompass the regions from the first point to the second point.

These embodiments of the present disclosure may provide improvement over some traditional approaches in that the presence of overlapping data between different data subsets may be reduced. Reduced overlapping data may provide more accurate assessment of the models as occurrences of inaccurate assessments are reduced. Such improved assessments may provide a more accurate view of areas of the models that may be improved.

### BRIEF DESCRIPTION OF THE DRAWINGS

The present systems and methods for optimizing dataset splits for machine learning systems and applications are described in detail below with reference to the attached figures, wherein:

FIG. 1 is a diagram illustrating an example system which may be configured to execute an AI model training pipeline based at least on operating data, in accordance with one or more embodiments of the present disclosure;

FIG. 2A illustrates a map representing multiple routes travelled by one or more machines to obtain sensor data, in accordance with one or more embodiments of the present disclosure;

FIG. 2B illustrates a map illustrating a geographical region divided into a set of cells, in accordance with one or more embodiments of the present disclosure;

FIG. 2C illustrates a map illustrating islands of cells, in accordance with one or more embodiments of the present disclosure;

FIG. 3 illustrates a flow diagram for a method for executing an AI model training pipeline based at least on operating data, in accordance with one or more embodiments of the present disclosure;

FIG. 4A is an illustration of an example autonomous vehicle, in accordance with one or more embodiments of the present disclosure;

FIG. 4B is an example of camera locations and fields of view for the example autonomous vehicle of FIG. 4A, in accordance with one or more embodiments of the present disclosure;

FIG. 4C is a block diagram of an example system architecture for the example autonomous vehicle of FIG. 4A, in accordance with one or more embodiments of the present disclosure;

FIG. 4D is a system diagram for communication between cloud-based server(s) and the example autonomous vehicle of FIG. 4A, in accordance with one or more embodiments of the present disclosure;

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

One or more embodiments of the present disclosure may relate to dividing a dataset into data subsets to reduce data leakage with respect to deployment and/or training of artificial intelligence (AI) models (e.g., machine learning models, neural networks, etc.). In some embodiments, the data subsets may include parts of the dataset that are split for different functions and purposes. For example, the dataset may be divided into a first data subset, a second data subset, and a third data subset.

In some embodiments, the first data subset may correspond to training data that may be used to train one or more AI models. The AI models may use the training data as ground truth data that is analyzed by the AI models to learn patterns and relationships between input features and outputs of the training data. Such patterns may be used to make predictions to determine outputs based on provided inputs. In some embodiments, the predictions of the AI models may be used to perform one or more navigational operations with respect to the operational scenarios.

In these and other embodiments, the second data subset may correspond to validation data. The validation data may be used to evaluate the performance of the AI models during training. For example, during training of the AI models, the validation data may be used to determine current performance of the AI models by providing the validation data as input data for the AI models.

In these and other embodiments, the third data subset may correspond to testing data. After the AI models are trained, the testing data may be used to assess the performance of the AI models with respect to accurately determining a particular output based on a particular input. For example, the AI models may include one or more key performance indicators (KPIs) associated therewith and the testing data may be provided to the AI models to determine how well the predictions made by the AI models based on the testing data perform with respect to the KPIs.

In some embodiments, datasets used in the training of AI models (e.g., used in the training, validating, and/or testing of AI models) may correspond to operating sessions of machines (e.g., ego-machines). For example, a machine may collect data (e.g., using one or more sensors corresponding to the machine) as the machine navigates an area (e.g., roadway or other location). The collected data may be included in datasets used in the training of AI models in some embodiments. The collected data may be referred to generically as “operating data” in the present disclosure. In instances in which the collected data corresponds to driving of a vehicle, the operating data may be referred to as “driving data.”

Additionally or alternatively, the operating data may correspond to certain geographic locations. For example, sensor data included in the operating data that is captured while the machine is at a particular location may correspond to such a location and may include information about such a location.

In these and other embodiments, as discussed in detail in the present disclosure, in one or more embodiments, a geographical region may be divided into non-overlapping cells (based at least on a corresponding map of region) such that the cells represent particular areas within the geographical region. In these and other embodiments, one or more subsets of cells may be grouped into “islands” of cells. The grouping of the cells into islands may be based on operating routes such that the islands may individually correspond to different operating routes. In these and other embodiments, an island may be a non-overlapping (or at least partially non-overlapping) group of one or more cells oriented to geographically align with an operating route. In some embodiments, the cells corresponding to an island may be adjacent to each other. Additionally or alternatively, the islands may be such that cells that are assigned to an island may not be assigned to other islands such that there may not be overlap between cells of islands. In the present disclosure, reference to a “cell” or an “island” may also refer to the geographic areas to which the cells or islands correspond. In some embodiments, multiple islands may correspond to a same operating route. For example, the cells corresponding to a particular operating route may be assigned to separate islands.

In these and other embodiments, operating data from operating sessions may be assigned to the cells that include the respective locations to which the operating data corresponds. Additionally or alternatively, the operating data that corresponds to a particular cell (e.g., that is assigned to the particular cell) may be assigned to the island to which the particular cell corresponds. In the present disclosure reference to the terms “island” and “cell” may also to refer to specific data that corresponds to the island and/or cell.

In these and other embodiments, the islands may be individually assigned to a particular data subset category. For example, the islands may be individually assigned to correspond to training data, validation data, or testing data. Additionally or alternatively, each island may only be assigned to one of such categories. In these and other embodiments, the operating data corresponding to the different islands may be used for training of an AI model based on the island designations of the islands to which the operating data corresponds.

In some embodiments, a machine configured to record operating data may travel along various routes while recording operating data along the routes. For example, the machine may be associated with one or more sensors (e.g., cameras, RADARs, LiDAR's, ultrasonic sensors, etc.) configured to record the operating data of the machine along the routes. In these and other embodiments, the operating data may include image data, RADAR data, LiDAR data, ultrasonic data, accelerometer data, inclinometer data, location data, user inputs (accelerator pedal, brake pedal, steering wheel, etc.), among others.

In some embodiments, the routes may be associated with the corresponding geographical area. In some embodiments, the geographical area may be represented using one or more geographical cells. For example, a geographical region. In these and other embodiments, the cells may divide the region such that the cells cover the entire area without any uncovered areas. In some embodiments, a reference to a cell may correspond to a reference to the geographical area corresponding to the cell. In these and other embodiments, the operating data corresponding to and/or obtained in a particular area corresponding to a particular cell may be associated with the particular cell. In the present disclosure, a reference to a particular cell may include a reference to the operating data associated with the particular cell.

In some embodiments, groups of cells may be organized into islands. In some embodiments, an island may include one or more cells corresponding to a particular route. For example, the cells corresponding to the geographical areas included in the particular route may be organized into an island. In these and other embodiments, the operating data may be split and assigned to different data subsets on island-by-island basis such that operating data corresponding to cells of the same island are assigned to a same data subset.

For example, in some embodiments, the islands may be individually assigned to a certain data subset category (e.g., training data, validation data, or testing data). In these and other embodiments, the operating data corresponding to the individual islands may be assigned to one of the first data subset, the second data subset, or the third data subset based on the subset categories corresponding to their respective islands. For example, the first data subset may be designated for training and the operating data of an island assigned to training data may accordingly be assigned to the first data subset and accordingly used for training of one or more the AI models. In some embodiments, the islands may be assigned to different data subsets based at least on characteristics of the operating data corresponding to the islands. For example, the characteristics of the operating data may include different operational scenarios (e.g., driving at nighttime) associated with the operating data.

One or more embodiments of the present disclosure may help reduce data leakage in training, validating, and testing AI models. For example, some traditional approaches may include randomly splitting available operating data to data subsets for training, validating and testing the AI models. Such approaches may not provide accurate assessment of the AI models. For example, data leakage or data overlap between the data subsets may occur which may cause the AI models to appear to perform better during validation or testing than the resulting performance in deployment.

The data leakage may be caused by static overlaps and/or dynamic overlaps. A static overlap may occur when overlapping pieces of data are used for both training and validation or testing. For example, in the context of ego-machines operating on a road network, overlapping pieces of data may include images of an intersection from the same or different data collection instances which are very similar or nearly identical because they have been taken from similar angles, correspond to the same geographic location/features/objects, and/or the like. If, for example, these overlapping pieces of data are used to both train and validate, validation may be less effective or yield improper, deceiving, or inaccurate results.

A dynamic overlap may occur when an ego-machine in moving through an area with other objects or detectable elements that are also moving through the area. For example, if an ego-machine is moving at the same or similar speed as another vehicle, that other vehicle may be detected by RADAR, camera, or the like multiple times in a relatively similar position/orientation to the ego-machine even though the ego-machine has dynamically moved along a path. Because the corresponding data portions may be visually highly similar, use of the different portions of data for both training and validation may be less effective or yield improper or inaccurate results.

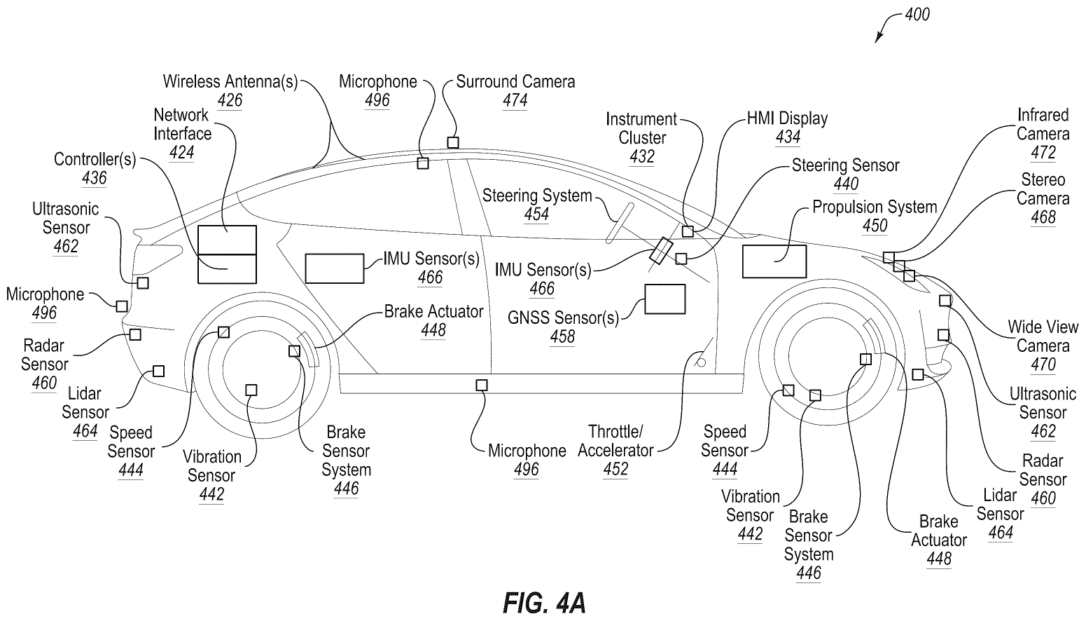

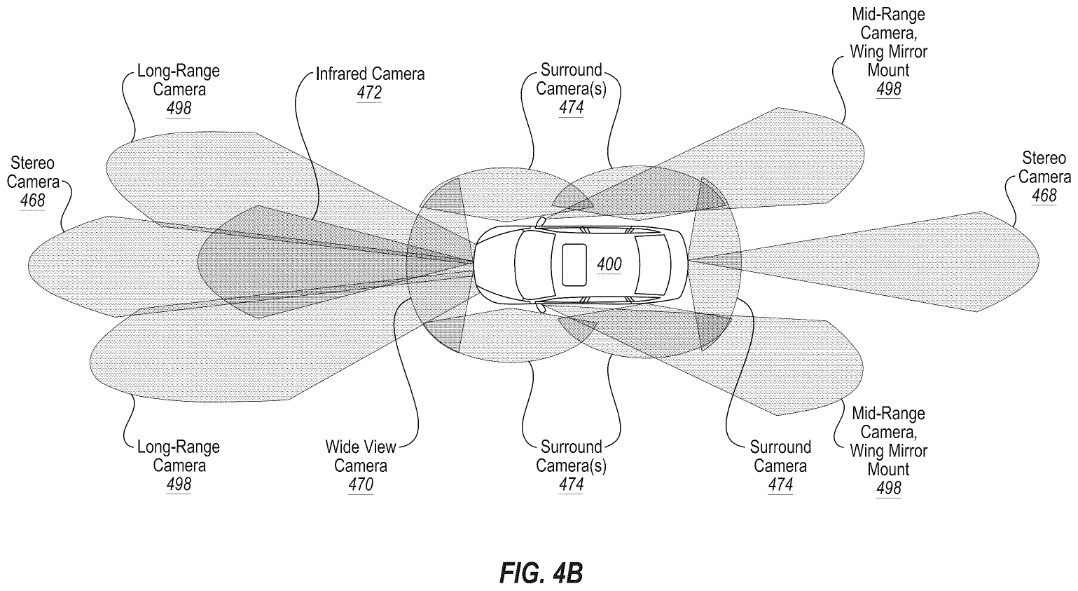

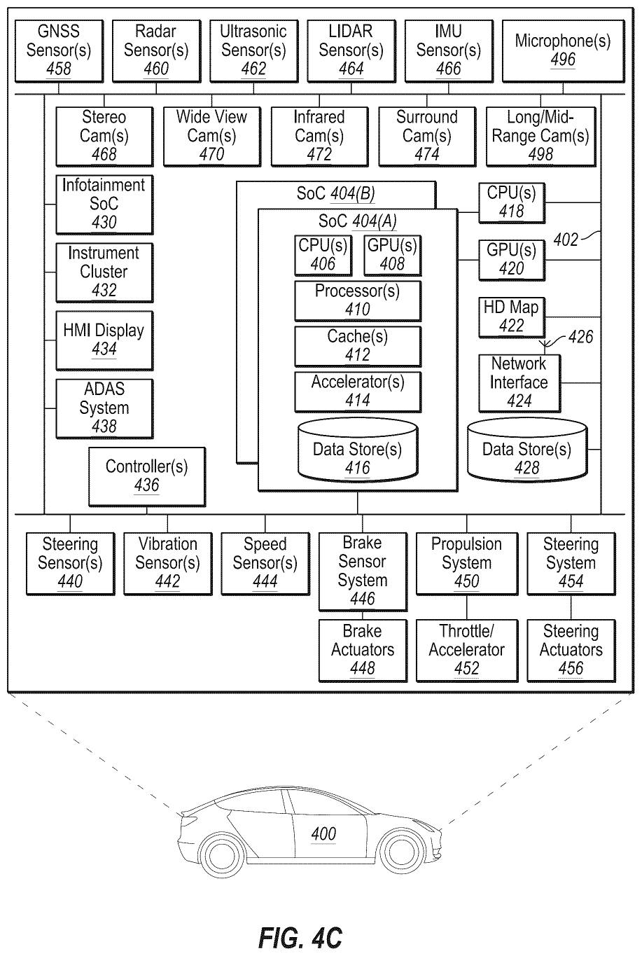

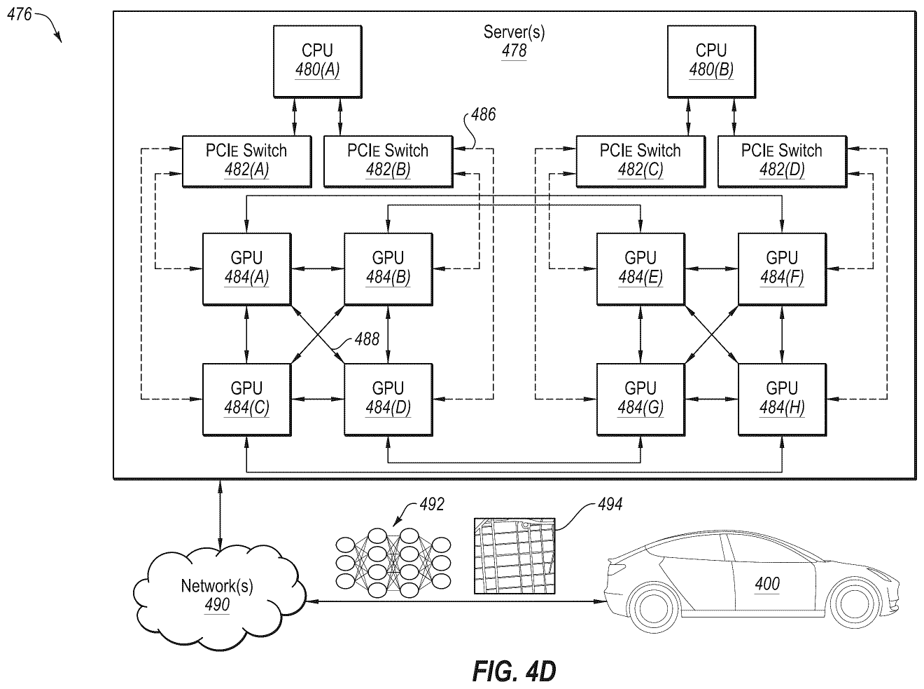

One or more embodiments of the present disclosure may be related to reducing data leakage for AI models associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 400 (alternatively referred to herein as “vehicle 400” or “ego-machine 400”) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI, data center processing, conversational AI (such as by employing one or more language models such as one or more large language models (LLMs), one or more visual language models (VLMs), and/or other model types), light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more language models, such as large language models (LLMs)), systems for performing one or more generative AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

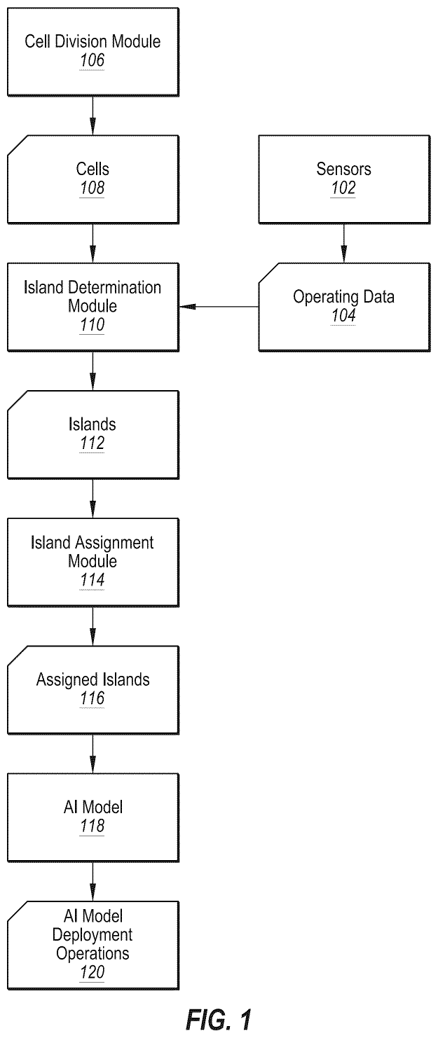

With respect to FIG. 1, FIG. 1 illustrates an example system 100 configured to determine executing an AI model deployment based at least on operating data, in accordance with one or more embodiments of the present disclosure. In some embodiments, the deployment of AI model may include training the AI model for a particular purpose such that the AI model is set up to process real-world data. In some embodiments, the system 100 may include multiple types of sensors associated with a machine. For example, in some embodiments, the system 100 may include one or more image sensors, RADAR sensors, LiDAR sensors, ultrasonic sensors, and/or other types of sensors.

In some embodiments, the sensors 102 may be configured to generate operating data 104. For example, the sensor data generated using the sensors 102 may be referred to as the operating data 104. In some embodiments, the operating data 104 may correspond to a dataset used in the AI model deployment. For example, the operating data 104 may be used in training, validating, and/or testing the AI model. In some embodiments, the sensors 102 may be associated with a machine. For example, the machine may navigate an area and collect data using the sensors 102. The collected data may correspond to the operating data 104. In some embodiments, the operating data 104 may correspond to certain geographic locations. For example, the operating data that is captured while the machine and/or the sensors 102 are at a particular location may correspond to such a location and may include information about such a location.

In some embodiments, the sensors 102 may generate the operating data 104 with respect to one or more operational scenarios. For example, the machine may travel along various routes including one or more operational scenarios, and the sensors 102 may generate the operating data 104 along the various routes. The operational scenarios may include environmental variables that may affect navigational operations of the ego-machines such as features, situations, and/or conditions, and the operating data 104 may include data related to such environmental variables generated based at least on various types of sensors 102. For example, the sensor data 104 may include image data, RADAR data, LiDAR data, ultrasonic data, among others. In some embodiments, the operating data 104 may be referred to as sensor data and/or driving data.

In some embodiments, the operating data 104 may be generated using multiple sets of sensors 102 associated with different machines. For example, different machines associated with corresponding set of sensors may travel along various routes to generate the operating data 104. For example, in some embodiments, the operating data 104 may be data accumulated from different sets of sensors. In some embodiments, the operating data 104 may be grouped together based at least on the various routes. For example, the operating data 104 obtained from the same route may be grouped together for future processes.

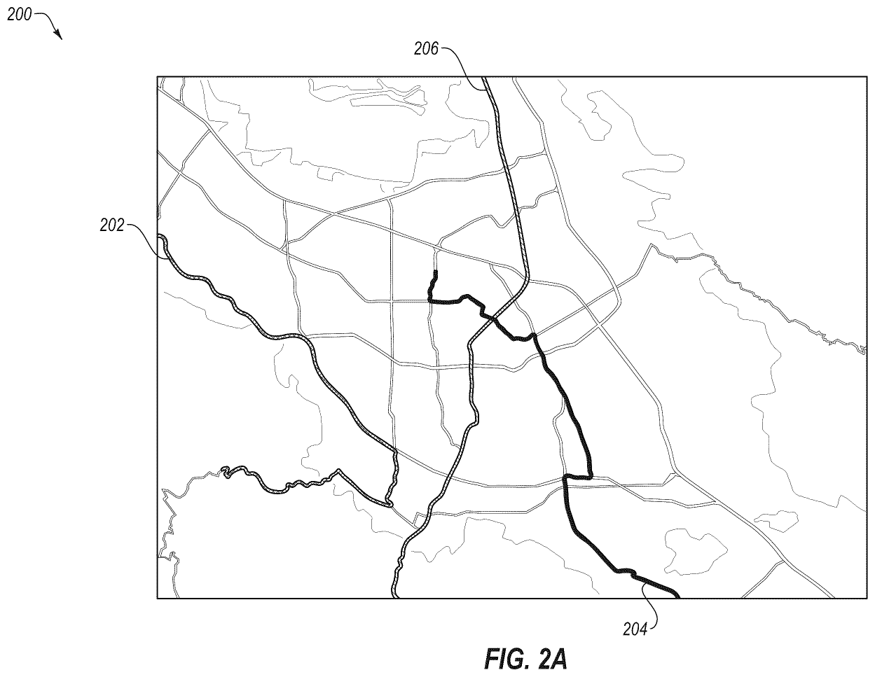

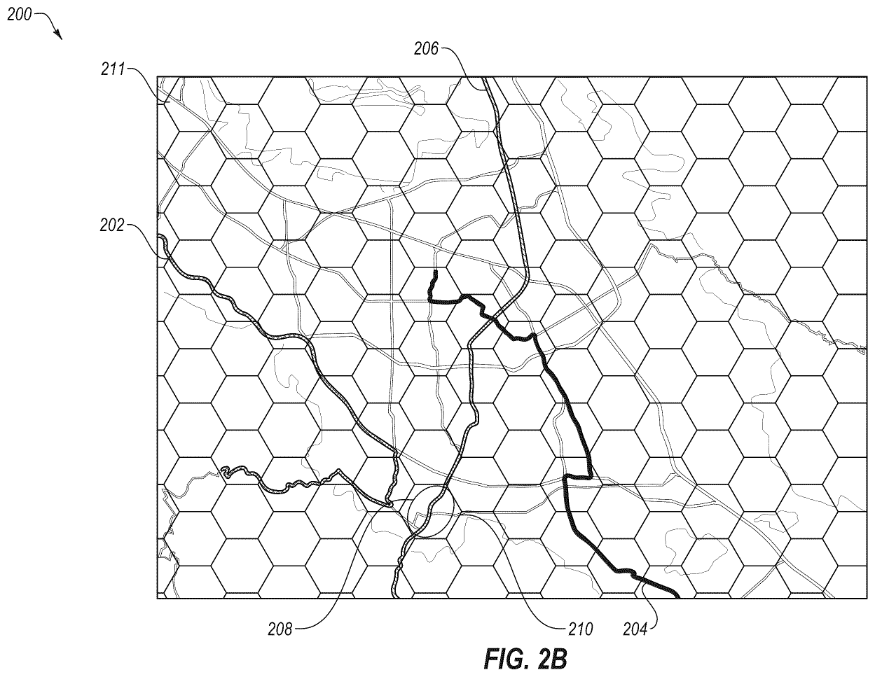

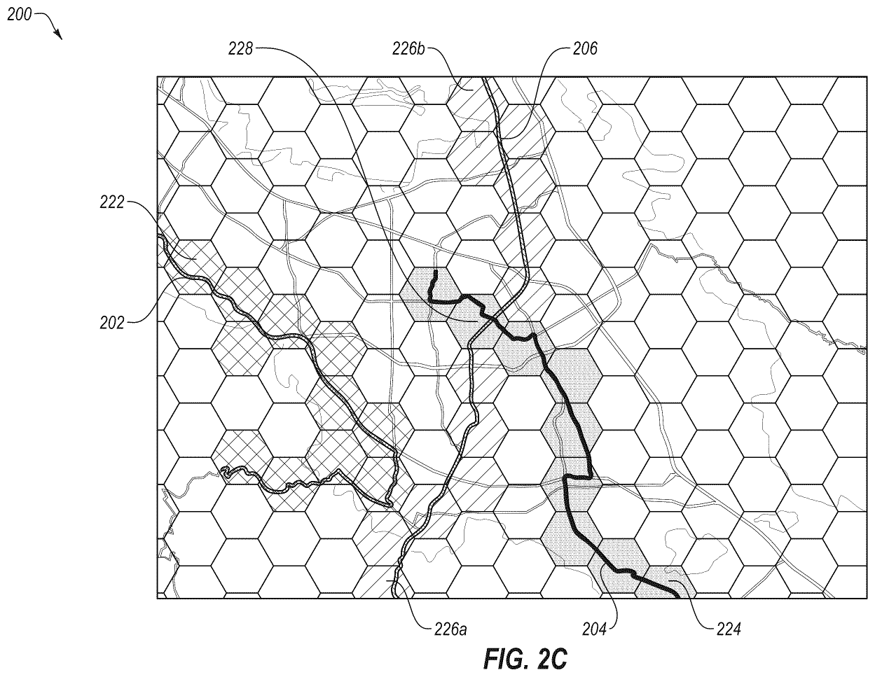

For example, FIG. 2A illustrates a map 200 representing multiple routes travelled by one or more machines to obtain sensor data, such as the sensor data 104 of FIG. 1, in accordance with one or more embodiments of the present disclosure. For example, as the one or more machines travel along the multiple routes, one or more sensors (e.g., the sensors 102 of FIG. 1) associated with the one or more machines may obtain operating data 104 corresponding to operational scenarios of the geographical area along the multiple routes. In some embodiments, the multiple routes may include different types of roads and/or off-roads that the one or more machines may travel. For example, the multiple routes may include highways, local streets, rural roads, freeways, expressways, bicycle paths, off-roads, among others.

In some embodiments, the map 200 may be used to represent a certain geographical area. In the present example, the map 200 illustrates a first route 202, a second route 204, and a third route 206. In some embodiments, the first route 202, the second route 204, and the third route 206 may be at least partially different. Operating data, such as operating data 104, obtained while travelling along the routes may be accumulated.

Returning to FIG. 1, in some embodiments, the system 100 may include a cell division module 106 configured to define cells 108. In some embodiments, the cells 108 may divide a geographical region (e.g., the world, or at least a part of the world) into (at least partially) non-overlapping areas (based at least on a corresponding map of the region) such that the cells represent particular areas within the geographical region.

In some embodiments, the cells 108 may include geometrical shapes that may cover the geographical region without overlaps and/or gaps. For example, the cells 108 may have hexagonal (or polygonal, or triangular, or square, or other shapes) shapes that lock or connect with each other such that no overlaps or gaps exist between the cells 108. In some embodiments, the cells 108 may include any other suitable geometrical shapes such as squares, triangles, trapezoids, rectangles, among others.

In some embodiments, the cells 108 may have same sizes. For example, the cells 108 may be shaped and sized in a same manner such that individual cells cover same sizes of geographical areas. Additionally or alternatively, the cells 108 may have varying sizes. For example, certain cells may be larger than other cells. In some embodiments, the cells 108 may be sized based at least on density of operating data 104 and/or environmental information (e.g., road density, population density, etc.) available in the cells 108. For example, areas with higher amount of operational scenarios and/or higher density of roads may be defined using smaller cells than areas with less amount of operational scenarios and/or lower density of roads, such that the cells 108 include similar amount of available operating data 104.

In some embodiments, the operating data 104 may be assigned to corresponding cells. For example, the operating data 104 may be assigned to the cells that include the respective locations to which the operating data 104 corresponds. In the present disclosure, a reference to the cells 108 may also refer to the operating data 104 associated therewith. Additionally, a reference to the operating data 104 may also refer to the cells 108 associated therewith.

For example, FIG. 2B illustrates the map 200 of FIG. 2A region divided into a set of cells 211, in accordance with one or more embodiments of the present disclosure. In some embodiments, the cells 211 may divide the area represented in the map 200 such that the entire area of the map 200 is covered. In some embodiments, the cells 211 may include a geographical shape and may be configured to connect among the cells 211 such that there are no gaps or overlaps among the cells 211. For example, the cells 211 may have hexagonal shapes. While the cell 211 are illustrated as having same sizes and shapes, in some embodiments, the cells 211 may have varying sizes and/or shapes.

In some embodiments, the first route 202, the second route 204, and the third route 206 may be associated with one or more cells 211. For example, the areas corresponding to the first route 202, the second route 204, and the third route 206 may be associated with and/or pass through one or more cells 211.

In some embodiments, the first route 202 may include operating data corresponding to an area 208. For example, the first route 202 may travel through the area 208 and obtain the operating data therein. In some embodiments, the operating data obtained therein may be assigned to a cell corresponding to the area 208. For example, a first cell 210 may geographically align with the area 208. In these and other embodiments, the operating data associated with the area 208 may be assigned to the first cell 210. In these and other embodiments, a reference to the first cell 210 may also refer to the operating data corresponding to the area 208.

Returning to FIG. 1, in some embodiments, an island determination module 110 may group one or more subsets of the cells 108 to determine islands 112. The islands 112 may include a subset of cells that in which the operating data corresponding to the subset of cells are grouped together. For example, the operating data corresponding to the subset of cells may get associated with specific islands in which the subset of cells are grouped. For example, a first cell, a second cell, and a third cell may be grouped into a first island. In such instances, the operating data corresponding to the areas corresponding to the first cell, the second cell, and the third cell may get associated with the first island. In the present disclosure, a reference to the islands may also refer to the operating data associated with the islands. In some embodiments, the islands 112 may be the atomic unit of AI deployment operations. For example, the operating data 104 may be divided and processed on island-basis.

In some embodiments, the islands 112 may be determined and/or grouped based at least on operating routes taken by one or more machines. For example, the islands 112 may include the cells 108 respectively oriented to geographically align with individual operating routes. Additionally or alternatively, the islands 112 may be such that cells 108 that are assigned to an island 112 may not be assigned to other islands 112 such that there may not be overlap between cells of islands 112.

For example, in some embodiments, a partial overlap may occur between two or more routes. For example, a particular cell 108 may be part of two different routes. In these and other embodiments, a tie-breaker analysis may be performed to determine which route is the owning route for the particular cell 108. In some embodiments, the tie-breaker analysis may be performed based at least on characteristics of the operating data or the operating data 104 associated with the particular cell 108. For example, the tie-breaker analysis may be performed based at least on the number of frames, number of labeled data points, most time spent in a cell, among others.

For example, a first route and a second route may both go through the particular cell. The first route may record or obtain operating data with more frames and/or more labeled data points with respect to the particular cell or the area corresponding to the particular cell than the second route. For example, the sensors 102 may obtain the operating data 104 at certain frame rates. For example, the image sensors may obtain image data at 30 frames per second (fps), the RADAR sensors may have update rates ranging from 5 Hz to 20 Hz, the LiDAR sensors may obtain the LiDAR data at 30 fps, among others. In these and other embodiments more frames in the operating data corresponding to a particular area may represent longer time spent in the particular area. In some embodiments, the sensors 102 may be configured to modify the frame rates based at least on features being detected. For example, in response to detecting more features and/or more detailed features, the sensors 102 may increase the frame rates to capture additional operating data. Additionally or alternatively, the first route may spend longer time in the particular cell (e.g., travel along more roads) than the second route. In these and other embodiments, the island determination module 110 may assign the particular cell to a first island corresponding to the first route.

In some embodiments, types of operational scenarios associated with the particular cell may be considered in the tie-breaker analysis. For example, the operating data 104 with respect to the particular cell 108 for the first route may include data associated with certain operational scenarios that are more interesting than the operational scenarios detected in the operating data associated with the second route. In some embodiments, operating data with respect to operational scenarios that are less common may be deemed more interesting. For example, an off-road in the mountains may be less common than a freeway such that operating data 104 corresponding to the off-road route may be deemed less interesting than operating data 104 corresponding to the freeway.

Additionally or alternatively, certain operating data 104 may be deemed more or less interesting based on the conditions within which the operating data 104 was obtained. For example, frames of operating data 104 that correspond to or indicate adverse conditions or frames that may be hard for AI models to classify may be deemed as less interesting. For example, frames may include areas with snow, no road marking and/or dark that may be hard to classify. In some embodiments, such less interesting operating data may not be as valuable to the AI models. Accordingly, the route that has operating data with less fraction of such data may be determined as the owning route of the particular cell. In some embodiments, the frames in adverse conditions may be used to harden the AI models or to expose the AI models to difficult conditions. In such instances, the route with more fraction of such data may be determined as the owning route of the particular cell.

In some embodiments, the route and/or the corresponding island 112 that the particular cell is not assigned to may be split into two or more routes or islands 112 to exclude the particular cell. For example, in instances in which the particular cell is assigned to the first route and the corresponding first island, the second route may be divided into two routes and corresponding islands.

For example, FIG. 2C illustrates the map 200 of FIG. 2A in which the multiple islands are illustrated, in accordance with one or more embodiments of the present disclosure. In some embodiments, the map 200 may be divided into a set of cells in a similar manner as the map 200 of FIG. 2B. In some embodiments, the map 200 may include one or more islands comprised of a subset of cells. For example, the map 200 may include a first island 222, a second island 224, a third island 226a, and a fourth island 226b. In some embodiments, the first island 222 may correspond to the first route 202, the second island 224 may correspond to the second route 204, and the third island 226a and the fourth island 226b may at least partially correspond to the third route 206.

In some embodiments, the first island 222 may include cells corresponding to geographical areas that the first route passes. In some embodiments, the first island 222 may include all of the cells that the first route, at least partially, passes. For example, the first route may only partially go through a small portion of a certain cell. In such instances, the first island 222 may include the certain cell in entirety. In some embodiments, the first island 222 may include cells that the first route may adequately represent. For example, amount of operating data associated with the cells that the first route passes may be analyzed and the cells with operating data above a threshold amount may be included in the first island 222.

In some embodiments, the second route and the third route may have an overlap at an overlapping cell 228. For example, the second route and the third route may both pass through the geographical area corresponding to the overlapping cell. In these and other embodiments, a tie-breaker analysis may be performed at the overlapping cell to determine whether the second route or the third route is the owning route of the overlapping cell.

In some embodiments, the characteristics of the operating data associated with the overlapping cell with respect to the second route and the third route may be compared to determine the owning route. For example, the second route may have higher number of frames obtained with respect to the overlapping cell than the third route. Additionally or alternatively, the operating data associated with the second route may be related to operational scenarios that may be more valuable for the AI models than the operating data associated with the third route. In such instances, the second route may be determined as the owning route of the overlapping cell.

Accordingly, the second island 224 may be defined to include the entire second route, including the overlapping cell. Contrastingly, the third route may be divided into sub-routes, excluding the overlapping cell. For example, the third route may be divided into a first sub-route and a second sub-route, where neither the first sub-route nor the second sub-route includes the overlapping cell. In these and other embodiments, the third island 226a may be defined to include cells corresponding to areas associated with the first sub-route, and the fourth island 226b may be defined to include the cells corresponding to areas associated with the second sub-route.

Returning to FIG. 1, an island assignment module 114 may analyze the islands 112 and the operating data 104 associated with the islands 112 to assign the islands 112 to particular subset categories associated with AI model deployment. For example, the island assignment module 114 may assign individual islands 112 to a training set, a validating set, or a testing set. In these and other embodiments, the island assignment module 114 may make the assignments of the islands 112 on such that the operating data 104 associated with the islands 112 may be designated to the same set as the island 112 to which the operating data 104 respectively corresponds. In some embodiments, assigned islands 116 may represent the islands 112 (and the operating data respectively associated therewith) with the corresponding assignments to the training set, the validating set, or the testing set.

In some embodiments, the island assignment module 114 may determine the assigned islands 116 from scratch or prior to any cells being assigned. For example, the training set, the validating set, and/or the testing set may not have any operating data 104 assigned therein. In these and other embodiments, the island assignment module 114 may assign the islands 112 to the training set, the validating set, and the testing set to satisfy a fraction ratio between the sets. The fraction ratio may represent a ratio of the assigned islands 116 between the sets that may optimize the AI models. For example, for a particular AI model, the fraction ratio may be 60:20:20 between the training set, the validating set, and the testing set. In such instances, the island assignment module 114 may assign the islands 112 to satisfy the fraction ratio.

In some embodiments, the operating data may be designed to optimize the sets. For example, in some embodiments, a linear solver (e.g., a mixed-integer solver) may be implemented to determine the assigned islands 116. For example, any suitable linear solver may be used to determine optimal distribution of the islands 112 to different sets based at least on the fraction ratio and/or one or more target distributions. In these and other embodiments, the target distributions may represent percentages of types of operating data to be designated to the sets. For example, a testing set for a particular AI model may be desired to have operating data in which at least four percent of the operating data is associated with motorbikes and at least three percent of the operation data is associated with dark lighting. In these and other embodiments, the linear solver may be tasked to identify islands including such operation data. In some embodiments, multiple types of operation data may be grouped for the linear solver. For example, the linear solver may be tasked to identify operation data associated with a motorbike AND dark lighting. In some embodiments, the validating set and the testing set may individually associated with desired target distributions. In some embodiments, the mixed-integer solver may be implemented with the islands 112 as the smallest atomic units. For example, the mixed-integer solver may determine assignments of the islands 112 on island-basis such that the operating data corresponding to a same island is assigned to a same data subset.

In these and other embodiments, the operating data 104 corresponding to the islands 112 may be analyzed such that the operating data may be assigned to satisfy the target distributions. For example, the first island may have operating data in which 18% is associated with dark lighting and 5% is associated with motorbikes, which may be used in designating the first island. For example, the first island may be designated to the training set to help satisfy the target distribution for the training set. In some embodiments, the training set, the validating set, and the testing set may be optimized in different orders based at least on various optimization modes indicating an order of optimization among the training set, the validating set, and the testing set. For example, in a certain optimization mode, the training set may be optimized first then the validating set and the testing set. In another example, the testing set may be optimized first then the training set and the validating set may be optimized. Additionally or alternatively, in yet another example, the testing set may be optimized based at least on the target distribution and the training set and the validating set be balanced based at least on the testing set such that the sets have similar distribution of operation data.

In some embodiments, the island assignment module 114 may designate new operating data after designating the initial set of islands. For example, a minor split may be performed with respect to the new operating data such that existing sets may be further optimized and/or improved. In some embodiments, the island assignment module 114 may designate the new operating data based at least on the target distributions such that the target distributions are optimized or maintained. In some embodiments, only the training set and the validating set may be subject to the minor split. For example, once the testing set is initialized, new data may not be added to the testing set.

In some embodiments, the new operating data may be associated with cells that have already been assigned to a set as part of the islands 112. For example, the new operating data may be associated with an area corresponding to the cell that has been assigned to the training set. In these and other embodiments, the new operating data may be assigned to the same set (e.g., the training set) such that no overlapping data with respect to the cell may be assigned to different sets. In some embodiments, the new operating data may be associated with a cell that has not been designated to a particular set. In these and other embodiments, the operating data associated with the cell may be designated following the process disclosed above. In some embodiments, the new operating data may be associated with an empty cell adjacent to an existing island and belong to a same owning route. In these and other embodiments, the new operating data may be merged with the operating data of the existing island and designated to the same set.

In some embodiments, the assignment islands 116 may be provided to an AI model 118. In some embodiments, the AI model 118 may be associated with an ego-machine such that the AI model 118 may determine one or more navigational operations with respect to the ego-machine. In some embodiments, the AI model 118 may perform AI model deployment operations 120 with respect to the operating data 104 associated with the assigned islands 116. For example, the AI model 118 may be trained, validated, and tested based at least on the training set, the validating set, and the testing set corresponding to the assigned islands 116.

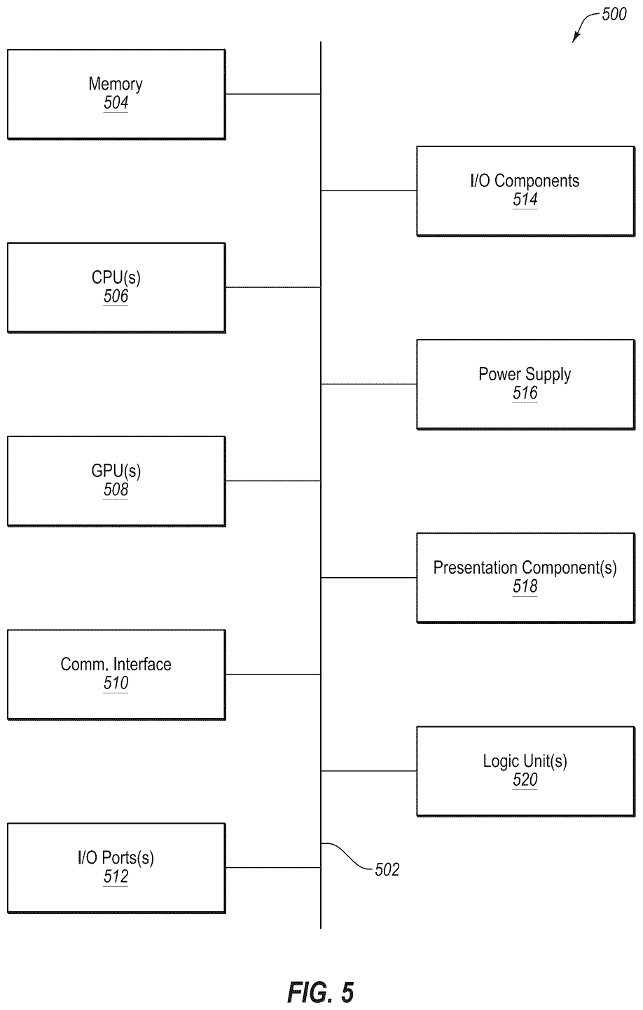

In some embodiments, one or more of the modules and/or processes described herein may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as that described in further detail with respect to FIG. 5.

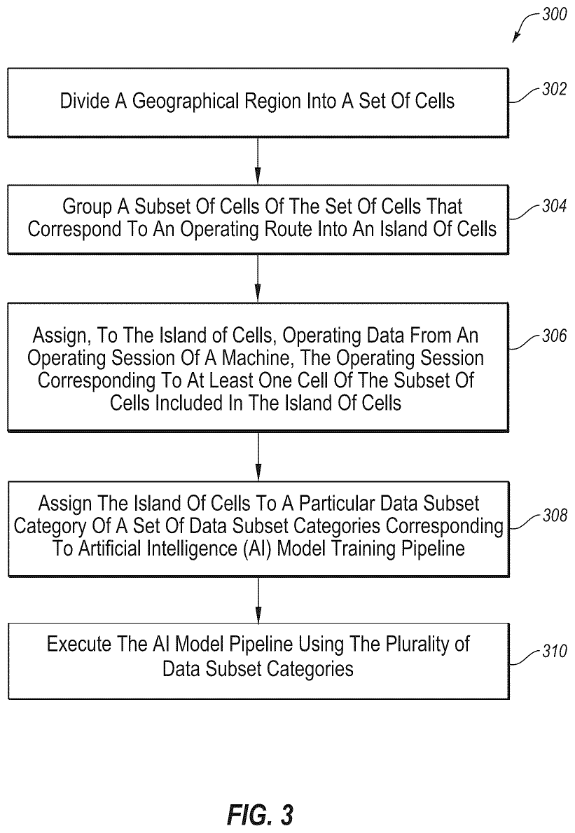

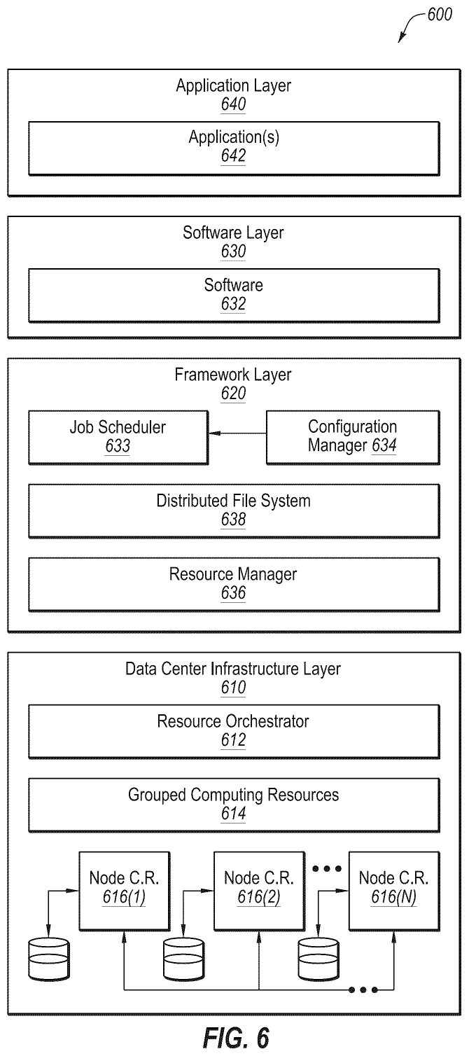

FIG. 3 is a flow diagram for a method 300 for executing an AI model deployment based at least on operating data, in accordance with one or more embodiments of the present disclosure. One or more operations of the method 300 may be performed by any suitable system, apparatus, or device such as, for example, the system 100 of FIG. 1, the autonomous vehicle system(s) described with respect to FIGS. 4A-4D, computing device(s) described with respect to FIG. 5, and/or the data system(s) described with respect to FIG. 6 in the present disclosure.

The method 300 may include one or more blocks. Although illustrated with discrete blocks, the operations associated with one or more of the blocks of the method 300 may be divided into additional blocks, combined into fewer blocks, or eliminated, depending on the particular implementation.

The method 300 may include block 302. At block 302, a geographical region may be divided into a set of cells. In some embodiments, the geographical region may be divided based at least on a corresponding map of the region. For example, the map of the region may be divided into the set of cells and the physical regions corresponding to the map may correspond to the cells on the map. In some embodiments, the set of cells may be defined such that the set of cells are non-overlapping. Additionally, the geographical region may be divided such that no area within the region is left without a corresponding cell. For example, the entire region may be divided using the set of cells.

In some embodiments, the set of cells may have geometrical shapes. For example, the cells may have hexagonal shapes. In these and other embodiments, the sides of individual hexagonal cells may mate and/or connect with sides other individual hexagonal cells. In some embodiments, the cells may have any other suitable shapes such as polygons, rectangles and triangles.

At block 304, a subset of cells of the set of cells that corresponds to a first operating route of a machine may be grouped into a first island of cells. In some embodiments, the first operating route may include adjacent regions travelled by the machine within the geographical region. For example, the machine may begin travelling at a starting point and end operating at an end point. The first operating route may include the region ranging from the starting point to the end point.

In some embodiments, the first operating route may include regions corresponding to the subset of cells. In these and other embodiments, the cells associated with the first operating route may be grouped together into a grouping such as the first island corresponding to the first operating route. For example, the first island or the subset of cells may be oriented to geographically align with the first operating route.

At block 306, operating data from an operating session of the machine to at least may be assigned to the first island of cells, in which the operating session corresponds to at least one cell of the subset of cells included in the first island of cells. For example, the operating data may be assigned to the cells that include the respective locations to which the operating data corresponds. Additionally or alternatively, the operating data that corresponds to a particular cell may be assigned to the first island to which the particular cell corresponds.

At block 308, the first island may be assigned to a particular data subset category of a set of data subset categories corresponding to AI model training pipeline. In some embodiments, the AI model training pipeline may include one or more operations that may be performed to train the AI model for a particular purpose. In these and other embodiments, the set of data subset categories may correspond to different groupings of the data corresponding to the one or more operations. For example, the first island may be assigned to a training data subset, a validating data subset, or a testing data subset. In these and other embodiments, the first island may only be assigned to one data subset. For example, once the first island and the corresponding operating data are assigned to the particular data subset category, the first island may not be assigned to another data subset category. In the present disclosure, a reference to an island may include a reference to the operating data corresponding to the island.

In some embodiments, the first island may be assigned to the particular data subset category based at least on characteristics of the operating data and target data distributions corresponding to the set of data subset categories. The characteristics of the operating data may include different types of operational scenarios associated with the operating data. In some embodiments, the target data distributions may include fractions of data shares among the set of data subset categories. Additionally or alternatively, the target data distributions may include desired types and fractions of operating data (e.g., with respect to the operational scenarios) for the set of data subset categories.

At block 310, an AI model training pipeline may be executed using the set of data subset categories. In some embodiments, the AI model training pipeline may include operations that may set up the AI model to be implemented in real world. For example, the AI model training pipeline may include training, validating, and/or testing the AI model. In these and other embodiments, the AI model may be trained, validated, or tested using the operating data corresponding to the first island based at least on the particular data subset category the first island was assigned. For example, in instances in which the first island is assigned to the training data subset, the AI model training pipeline may include training the AI model with respect to the first island.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

For example, the method 300 may further include obtaining new operating data corresponding to at least one cell of the plurality of cells. The at least one cell may be part of a new operating route travelled by the machine. In some embodiments, the at least one cell may be compared to the subset of cells assigned to the first island. For example, a possible overlap between the at least one cell and the first island may be identified.

In response to determining that the at least one cell one cell overlaps with the first island the new operating data associated the at least one cell may be assigned to the first island or the particular data subset category that the island is assigned. In some embodiments, the at least one cell may no overlap with the first island. In these and other embodiments, the location of the at least one cell may be analyzed to determine whether the at least one cell is adjacent to one or more cells of the first island. In response to determining that the at least one cell is not adjacent to the first island, the new operating data may be assigned to one of the data subset categories of the plurality of data subset categories in a similar manner the first island was assigned.

In some embodiments, the at least one cell may be adjacent to one or more cells of the first island. In these and other embodiments, the owning route of the at least one cell may be determined. In response to determining that the at least one cell shares the owning route with the first island, the new operating data may be merged with the first island and assigned to the particular data subset category.

In some embodiments, the method 300 may further include grouping a second subset of cells of the plurality of cells that corresponds to a second operating route into a second island of cells. In some embodiments, the second operating route may be at least partially different from the operating route. In these and other embodiments, the operating data form the operating session of the machine that corresponds to at least one cell of the second subset of cells included in the second island may be assigned to the second island.

In some embodiments, the second island may be assigned to a data subset category of the plurality of data subset categories. In some embodiments, the second island may be assigned to the same data subset category as the first island. In other embodiments, the second island may be assigned to different data subset category from the first island.

In some embodiments, an overlap between the first operating route and the second operating route may be identified. For example, the first operating route and the second operating route may overlap with respect to an overlapping cell, which may be determined based at least on the overlapping region between the first operating route and the second operating route. In these and other embodiments, a tie-breaker analysis may be performed between the first operating route and the second operating route to determine an owning route of the overlapping cell. In some embodiments, the tie-breaker analysis may be discussed in further detail with respect to FIG. 1 and FIG. 2C of the present disclosure.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red, blue, green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an LO instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined LI data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 404 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPD (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surrounding at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 100 m, with an accuracy of 2 cm-3 cm, and with support for a 100 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 400), while the I2V communication concept provides information about traffic further ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's Tensor®). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, include wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 632, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 600. In at least one embodiment, trained or deployed machine learning models corresponding to one or more neural networks may be used to infer or predict information using resources described in the present disclosure with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.
Example 1. A method comprising:
dividing a geographical region into a plurality of cells;
grouping a subset of cells of the plurality of cells that correspond to an operating route, into an island of cells;
assigning, to the island of cells, operating data from an operating session of a machine, the operating session corresponding to at least one cell of the subset of cells included in the island of cells;
assigning the island of cells to a particular data subset category of a plurality of data subset categories corresponding to artificial intelligence (AI) model training pipeline; and
executing the AI model pipeline using the plurality of data subset categories.

The method of Example 1, wherein the island of cells is oriented to geographically align with the operating route.

The method of Example 1, wherein the plurality of data subset categories include a training data subset, a validation data subset, and a testing data subset.

The method of Example 1, wherein the island of cells is assigned to the particular data subset category based on one or more of: one or more characteristics of the operating data or one or more target data distributions corresponding to the plurality of data subset categories.

The method of Example 1, further comprising:
obtaining new operating data corresponding to at least one cell of the plurality of cells; and
in response to determining that the at least one cell overlaps with the subset of cells, assigning the new operating data to the island of cells.

The method of Example 1, further comprising:
obtaining new operating data corresponding to at least one cell of the plurality of cells;
in response to determining the at least one cell does not overlap with the subset of cells:
assigning the new operating data to a new island of cells; and
assigning the new island of cells to a certain data subset category of the plurality of data subset categories.

The method of Example 1, further comprising:
obtaining new operating data corresponding to at least one cell of the plurality of cells;
comparing the at least one cell to the subset of cells;
in response to determining the at least one cell does not overlap with the subset of cells:
determining that the at least one cell is adjacent to one or more cells of the subset of cells; and
assigning the new operating data to the island of cells.

The method of Example 1, further comprising:
grouping a second subset of cells of the plurality of cells that corresponds to a second operating route into a second island of cells;
assigning, to the second island of cells, the operating data from the operating session of the machine that corresponds to at least one cell of the second subset of cells included in the second island of cells; and
assigning the second island of cells to a data subset category of the plurality of data subset categories.

The method of Example 1, further comprising:
in response to determining an overlap between the operating route and the second operating route:
determining at least one overlapping cell based at least on an overlapping region between the operating route and the second operating route; and
performing a tie-breaker analysis between the operating route and the second operating route to determine an owning route of the at least one overlapping cell.

The method of Example 1, wherein the plurality of cells are hexagons, polygons, rectangles, or triangles.
Example 2. A system comprising:
one or more processors to cause performance of operations comprising:
grouping a first subset of cells of a plurality of cells that corresponds to a first operating route through a geographical region into a first grouping of cells;
grouping a second subset of cells of the plurality of cells that corresponds to a second operating route through the geographical region into a second grouping of cells;
assigning, to the first grouping, first operating data from a first operating session of a machine that corresponds to at least one cell of the first subset of cells included in the first grouping;
assigning, to the second grouping, second operating data from a second operating session of the machine that corresponds to at least one cell of the second subset of cells included in the second grouping;
assigning the first grouping to a first data subset category of a plurality of data subset categories corresponding to an artificial intelligence (AI) model training pipeline;
assigning the second grouping to a second data subset category of the plurality of data subset categories corresponding to the AI model training pipeline; and
executing the AI model pipeline using the first grouping as the first data subset category and the second grouping as the second data subset category.

The system of Example 2, wherein the first data subset category and the second data subset category are the same.

The system of Example 2, wherein the first data subset category and the second data subset category are different.

The system of Example 2, wherein the plurality of data subset categories includes a training data subset, a validation data subset, and a testing data subset.

The system of Example 2, wherein the first grouping and the second grouping do not have an overlapping cell between them.

The system of Example 2, wherein the first grouping and the second grouping are oriented to geographically align with their respective operating routes.

The system of Example 2, wherein the first grouping and the second grouping are assigned to the first data subset category and the second data subset category, respectively, based on one or more of: one or more characteristics of the first operating data and the second operating data, or one or more target data distributions corresponding to the plurality of data subset categories.

The system of Example 2, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system implementing one or more visual language models (VLMs);
a system incorporating one or more virtual machines (VMs);
a system implemented at least partially in a data center; or
a system implemented at least partially using cloud computing resources.
Example 3. one or more processors comprising:
processing circuitry to cause performance of operations comprising:
grouping a subset of cells of a plurality of cells that correspond to an operating route into a group of cells;
assigning operating data from an operating session of a machine to the group based at least on the operating data corresponding to at least one cell of the subset of cells included in the group;
assigning the group to one of a training data category, a validation data category, or a testing data category associated with an AI model training pipeline; and
executing the AI model training pipeline using the operating data from the group as either training data, validation data, or testing data based at least on the assigning of the group to one of a training data category, a validation data category, or a testing data category.

The one or more processors of Example 3, wherein the group of cells is assigned based at least on characteristics of the operating data, target data distribution information, and an optimization mode indicating an order of optimization among the training data category, the validation data category, and the testing data category.

What is claimed is:

1. A method comprising:
dividing a geographical region into a plurality of cells;
grouping a subset of cells of the plurality of cells that correspond to an operating route, into an island of cells;
assigning, to the island of cells, operating data from an operating session of a machine, the operating session corresponding to at least one cell of the subset of cells included in the island of cells;
assigning the island of cells to a particular data subset category of a plurality of data subset categories corresponding to artificial intelligence (AI) model training pipeline; and
executing the AI model pipeline using the plurality of data subset categories.

2. The method of claim 1, wherein the island of cells is oriented to geographically align with the operating route.

3. The method of claim 1, wherein the plurality of data subset categories include a training data subset, a validation data subset, and a testing data subset.

4. The method of claim 1, wherein the island of cells is assigned to the particular data subset category based on one or more of: one or more characteristics of the operating data or one or more target data distributions corresponding to the plurality of data subset categories.

5. The method of claim 1, further comprising:
obtaining new operating data corresponding to at least one cell of the plurality of cells; and
in response to determining that the at least one cell overlaps with the subset of cells, assigning the new operating data to the island of cells.

6. The method of claim 1, further comprising:
obtaining new operating data corresponding to at least one cell of the plurality of cells;
in response to determining the at least one cell does not overlap with the subset of cells: <assigning the new operating data to a new island of cells; and
assigning the new island of cells to a certain data subset category of the plurality of data subset categories.

7. The method of claim 1, further comprising:
obtaining new operating data corresponding to at least one cell of the plurality of cells;
comparing the at least one cell to the subset of cells;
in response to determining the at least one cell does not overlap with the subset of cells:
determining that the at least one cell is adjacent to one or more cells of the subset of cells; and
assigning the new operating data to the island of cells.

8. The method of claim 1, further comprising:
grouping a second subset of cells of the plurality of cells that corresponds to a second operating route into a second island of cells;
assigning, to the second island of cells, the operating data from the operating session of the machine that corresponds to at least one cell of the second subset of cells included in the second island of cells; and
assigning the second island of cells to a data subset category of the plurality of data subset categories.

9. The method of claim 8, further comprising:
in response to determining an overlap between the operating route and the second operating route:
determining at least one overlapping cell based at least on an overlapping region between the operating route and the second operating route; and
performing a tie-breaker analysis between the operating route and the second operating route to determine an owning route of the at least one overlapping cell.

10. The method of claim 1, wherein the plurality of cells are hexagons, polygons, rectangles, or triangles.

11. A system comprising:
one or more processors to cause performance of operations comprising:
grouping a first subset of cells of a plurality of cells that corresponds to a first operating route through a geographical region into a first grouping of cells;
grouping a second subset of cells of the plurality of cells that corresponds to a second operating route through the geographical region into a second grouping of cells;
assigning, to the first grouping, first operating data from a first operating session of a machine that corresponds to at least one cell of the first subset of cells included in the first grouping;
assigning, to the second grouping, second operating data from a second operating session of the machine that corresponds to at least one cell of the second subset of cells included in the second grouping;
assigning the first grouping to a first data subset category of a plurality of data subset categories corresponding to an artificial intelligence (AI) model training pipeline;
assigning the second grouping to a second data subset category of the plurality of data subset categories corresponding to the AI model training pipeline; and
executing the AI model pipeline using the first grouping as the first data subset category and the second grouping as the second data subset category.

12. The system of claim 11, wherein the first data subset category and the second data subset category are the same.

13. The system of claim 11, wherein the first data subset category and the second data subset category are different.

14. The system of claim 11, wherein the plurality of data subset categories includes a training data subset, a validation data subset, and a testing data subset.

15. The system of claim 11, wherein the first grouping and the second grouping do not have an overlapping cell between them.

16. The system of claim 11, wherein the first grouping and the second grouping are oriented to geographically align with their respective operating routes.

17. The system of claim 11, wherein the first grouping and the second grouping are assigned to the first data subset category and the second data subset category, respectively, based on one or more of: one or more characteristics of the first operating data and the second operating data, or one or more target data distributions corresponding to the plurality of data subset categories.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system implementing one or more visual language models (VLMs);
a system incorporating one or more virtual machines (VMs);
a system implemented at least partially in a data center; or
a system implemented at least partially using cloud computing resources.

19. One or more processors comprising:
processing circuitry to cause performance of operations comprising:
grouping a subset of cells of a plurality of cells that correspond to an operating route into a group of cells;
assigning operating data from an operating session of a machine to the group based at least on the operating data corresponding to at least one cell of the subset of cells included in the group;
assigning the group to one of a training data category, a validation data category, or a testing data category associated with an AI model training pipeline; and
executing the AI model training pipeline using the operating data from the group as either training data, validation data, or testing data based at least on the assigning of the group to one of a training data category, a validation data category, or a testing data category.

20. The one or more processors of claim 19, wherein the group of cells is assigned based at least on characteristics of the operating data, target data distribution information, and an optimization mode indicating an order of optimization among the training data category, the validation data category, and the testing data category.
